(19) United States
(12) Patent Application Publication
(10) Pub. No.: US 2009/0252294 A1
(43) Pub. Date: Oct. 8, 2009

(54) Scanning von hamos type x-ray spectrometer

(76) Inventor: David O'Hara, Tallahassee, FL (US)

Correspondence Address: WILEY HORTON, 215 SOUTH MONROE STREET, 2ND FLOOR, TALLAHASSEE, FL, 32301, US

(21) Appl. No.: 12/384,010

(22) Filed: Mar. 31, 2009

Related U.S. Application Data
(60) Provisional application No. 61/072,733, filed on Apr. 2, 2008.

(51) Int. Cl. G01N 23/20

(52) U.S. Cl. 378/71

(57) ABSTRACT

An X-ray spectrometer that collects a very large solid angle of emitted X-rays from a sample but “views” only a narrow portion of the X-rays at a time. The invention uses a moving detector, which moves along the optical axis, to count or collect X-rays from within narrow wavelength regions.

### CROSS-REFERENCES TO RELATED APPLICATIONS

This is a non-provisional application claiming the benefit, pursuant to 37 C.F.R. §1.53, of an earlier-filed provisional application. The provisional application was assigned Ser. No. 61/072,733. It was filed on Apr. 2, 2008 and it listed the same inventor.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates generally to the field of X-ray spectroscopy. More particularly, the present invention comprises a scanning Von Hamos type X-ray spectrometer.

2. Description of the Related Art

X-ray spectrometers of various configurations are known in the prior art. One such configuration for an X-ray spectrometer is a Von Hamos type X-ray imaging spectrometer. A conventional Von Hamos configuration is an imaging spectrometer where the image formed in the optical axis is a spectral image and images corresponding to various spectral lines are formed along the optical axis.

X-rays are diffracted off a shaped surface typically made of a suitable crystal. In most instruments a 1-D image is formed. This can be recorded using a CCD or other instrument. It is typical to “view” the entire image at one time, with the optical path of the Von Hamos spectrometer being fixed.

The X-ray paths in such devices are typically shown as distinct rays. This is an oversimplification, of course. Some degree of X-ray scatter is inevitable in any such device. This scatter causes background “noise” which degrades the image formed and the overall performance of the instrument. It is desirable to reduce such background noise, while still allowing the full spectrum to be analyzed.

### BRIEF SUMMARY OF THE PRESENT INVENTION

The present invention is an X-ray spectrometer that collects a very large solid angle of emitted x-rays from a sample, but only “views” a relatively narrow portion of the X-rays at any given time. The invention uses movable optical paths to isolate the desired narrow wavelength region while reducing scatter from other wavelength regions. The movable optical paths allow the entire available wavelength to be scanned as the optical paths are moved from a first extreme to a second extreme.

### BRIEF DESCRIPTION OF THE SEVERAL VIEWS OF THE DRAWINGS

FIG. 1 is an illustration of one embodiment of the present invention.

FIG. 2 is an illustration of one embodiment of the present invention.

### REFERENCE NUMERALS IN THE DRAWINGS

| | | | |
|---|---|---|---|
| 10 | X-ray spectrometer | 12 | first position |
| 14 | first position | 16 | second position |
| 18 | second position | 20 | aperture block |
| 22 | on-axis energy beam generator | 24 | energy beam |
| 26 | energy beam | 28 | optical axis |
| 30 | annular occluder | 32 | diffractor |
| 34 | annular occluder | 36 | diffractor |
| 38 | sample | 40 | X-ray spectrometer |
| 42 | first position | 44 | second position |
| 46 | conical diffractor | 48 | optical axis |
| 50 | hyperboloid diffractor | 52 | sample |
| 54 | energy beam | 56 | moving detector |
| 58 | adjustable aperture | 60 | moving detector |

### DETAILED DESCRIPTION OF THE INVENTION

The present invention is an X-ray spectrometer that collects a very large solid angle of emitted X-rays from a sample but “views” only a narrow portion of the X-rays at a time. The invention uses a moving detector, which moves along the optical axis, to count or collect X-rays in narrow wavelength regions.

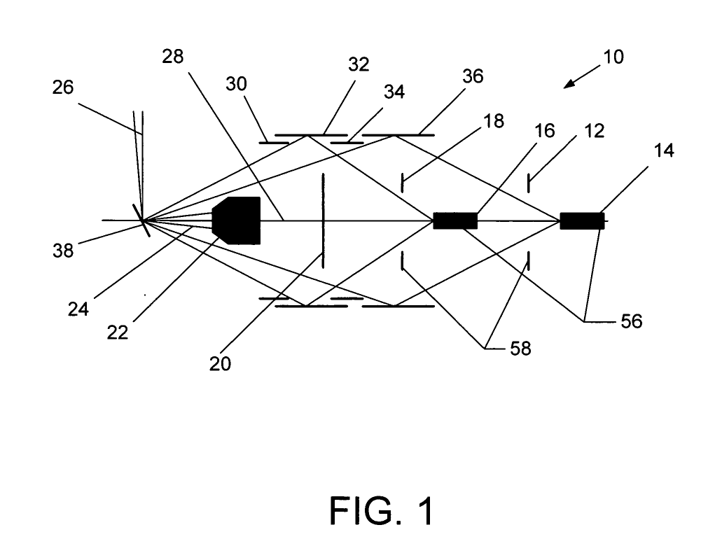

FIG. 1 is a section view taken through the central optical axis 28 of X-ray spectrometer 10. The components are preferably radially symmetric about optical axis 28. Energy beam 26 is focused on sample 38 to produce an excited small spot on sample 38 that emits characteristic X-rays. Alternatively, on-axis energy beam generator 22 may be provided to focus energy beam 24 on sample 38. Energy beam 26 and/or 24 may be X-rays, electrons or ions.

The X-rays emitted from the sample diverge at various angles depending upon the composition of sample 38 (as well as the angle of incidence of the energy beam). Cylindrical diffractors 32 and 36, which encircle optical axis 28, diffract the emitted X-rays. Annular occluders 30 and 34 only allow a relatively narrow portion of the emitted X-rays to strike diffractor 32 and 36. Thus, only the X-rays lying within a designated angular range are diffracted.

X-rays of different wavelengths diffract from different places along diffractors 32 and 36 (since they are emitted at different angles from the sample). Moving detector 56 moves along optical axis 28 and counts or collects X-rays which strike the detector at a given position. Moving detector 56 can be one of many types of X-ray detectors, including a simple X-ray counter or of the Energy Dispersive Spectrometer type (EDS). Whatever the type, the detector is preferably positioned and configured to collect X-rays from a narrow wavelength region.

In FIG. 1 moving detector 56 is shown at two different positions, as indicated by first position 14 and second position 16. It is movable anywhere between these two extremes. Adjustable aperture 58 moves along with moving detector 56. Adjustable aperture 58 has a circular opening, the width of which can be varied as desired (such as an iris).

In FIG. 1, adjustable aperture 58 is shown in first position 12 and second position 18. Since it moves along with the moving detector, it is able to move anywhere in between the two positions shown. Adjustable aperture is located in first position 12 when the moving detector is located in first position 14. Likewise, adjustable aperture is located at second position 18 when the moving detector is located at position 16.

Diffractors 32 and 36 are preferably also made movable. FIG. 1 shows two distinct ray paths taken by the X-rays—with one path corresponding to the position in which moving detector 56 is closest to the sample and one path corresponding to the position in which the moving detector is furthest from the sample. Those skilled in the art will realize that the diffractors do not need to move over as large a range as the moving detector. In fact, for some configurations, it may be possible to use one elongated diffractor for the entire range. However, the embodiment shown uses two diffractors which may be moved independently.

By moving detector 56 and diffractors 32 and 36 along the optical axis X-ray spectrometer 10 can be made to “scan” the emitted X-rays by wavelength. The spread in wavelengths moving detector 56 receives is determined by the width of an annular opening between annular occluders 30 and 34 and/or by the width of the opening of adjustable aperture 58 in front of the moving detector. The annular occluders are preferably able to move independently so that the width of the annular opening between the two can be varied. Aperture block 20 further serves to prevent scattered x-rays from reaching the moving detector.

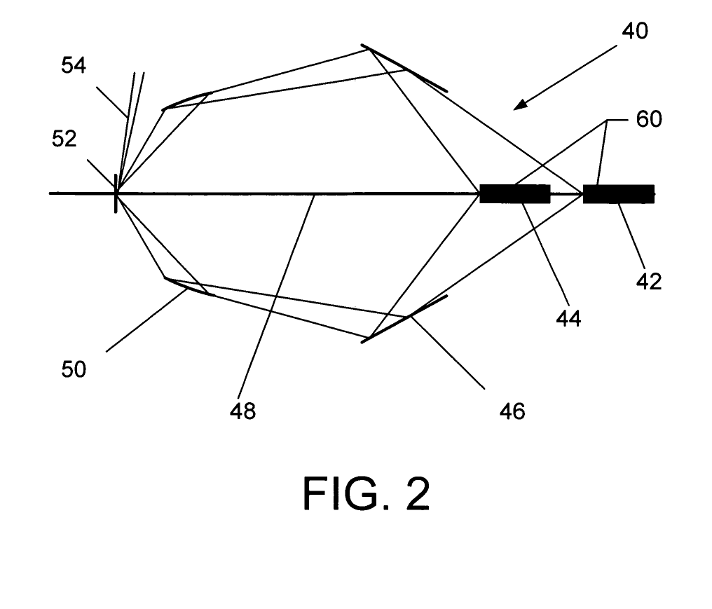

Turning to FIG. 2, a second embodiment of the invention is shown. FIG. 2 is a section view taken along the optical axis 48 of X-ray spectrometer 40. The components shown are preferably radially symmetric about the optical axis. In this embodiment hyperboloid diffractor 50 diffracts X-rays emitted by sample 52 when excited by energy beam 54. Hyperboloid diffractor 50 is a portion of a hyperboloid of revolution which is revolved about optical axis 48. The X-rays diffracted by hyperboloid diffractor 50 are then diffracted by conical diffractor 46 before striking moving detector 60.

In the illustrated embodiment, conical diffractor 46 forms the shape of a truncated cone with a center axis lying along optical axis 48. Conical diffractor 46 may also be a cylindrical diffractor (though this will make the device less compact). As described in the previous example, moving detector 60 moves along the optical axis and collects or counts X-rays by wavelength. In FIG. 2, moving detector 60 is shown in first position 42 and second position 44. The reader will observe that the hyperboloid diffractors and the conical diffractors are large enough to accommodate this range of motion for moving detector 60 without needing to be moved. However, the embodiment shown in FIG. 2 can also include moving hyperboloid and conical diffractors, as well as moving occluders and a moving adjustable aperture.

If an energy dispersive detector is used, conical diffractor 46 can be composed of different arc shaped pieces of different d-spacing so that the detector “sees” several different spectral regions at one time. By arranging for these spectral regions to be widely separated compared to the detectors intrinsic resolution, one can simultaneously measure several different spectral regions with the energy dispersive detector with the resolution of the curved diffractor.

It should be noted that various diffractive materials may be used for the diffractors of the present invention including, but not limited to, synthetic multilayer composites, Rubidium Acid Phthalate (RAP), Thallium Acid Phthalate (TAP), Lithium Fluoride (LiF), Highly Ordered Pyrolytic Graphite (HOPG), Silicon (Si), and other crystals.

Operation of the system can be understood by reference to FIG. 1. “Energy” beam 26 excites X-rays from sample 38. These X-rays diverge into a large solid angle and some reach diffractor 32 and 36 through the sliding annular opening between annular occluders 30 and 34. The sizing of the annular opening is variable, allowing the user to control the range of X-ray wavelengths which strike diffractors 32 or 36. Diffracted X-rays of a narrow wavelength range are then diffracted toward optical axis 28 where they are detected by the moving detector.

The specific wavelength range that reaches moving detector 56 is determined by the position of the annular opening and by the position of moving detector 56, both of which move along the optical axis in order to scan in wavelength. As such the diffractors only diffract a narrow range at a time or several narrow ranges at a time. The diffractor(s) move along the optical axis so as to provide various Bragg angles to the x-rays encountering it. The width of the diffractor can be adjusted to vary the wavelength spread of X-rays reaching the detector.

The X-ray detector moves along the optical axis to allow it to detect the X-rays diffracted by the moving diffractor. The adjustable aperture acts as a “variable iris” in front of the moving detector and acts to minimize the effects of background X-rays. It should be noted that the detector may be operated in energy dispersive mode so as to be able to analyze X-rays from multiple diffractors. Those that are skilled in the art will appreciate that such an X-ray spectrometer configuration of the present invention is therefore an excellent choice for X-Ray Fluorescence (XRF) or electron beam micro-analysis. The configuration of the present invention further allows for the X-ray source to be arranged such that the X-ray emitter is coincident with the optical axis.

Although the preceding descriptions contain significant detail they should not be viewed as limiting the invention but rather as providing examples of the preferred embodiments of the invention. As examples, the diffractors of the present invention may assume various shapes. Accordingly, the scope of the invention should be determined by the following claims, rather than the examples given.

Having described my invention, I claim:

1. A scanning Von Hamos X-ray spectrometer, comprising:
a. a central optical axis;
b. a sample located proximate said central optical axis;
c. an energy beam bombarding said sample in order to produce X-rays;
d. a diffractor, positioned to reflect and diffract said X-rays;
e. a movable occluder, positioned between said sample and said diffractor, wherein said movable occluder selectively occludes a portion of said X-rays striking said diffractor; and
f. a detector capable of detecting said reflected and diffracted X-rays, said detector being movably positioned along said central axis.

2. A scanning Von Hamos X-ray spectrometer as recited in claim 1, said movable occluder comprising a pair of annular occluders forming an annular gap therebetween.

3. A scanning Von Hamos X-ray spectrometer as recited in claim 1, further comprising an aperture controlling the admittance of said X-rays to said detector, wherein said aperture moves with said detector.

4. A scanning Von Hamos X-ray spectrometer as recited in claim 3, wherein said aperture is adjustable.

5. A scanning Von Hamos X-ray spectrometer as recited in claim 1, wherein said energy beam is generated by an on-axis energy beam generator located on said optical axis and facing away from said detector.

6. A scanning Von Hamos X-ray spectrometer as recited in claim 1, wherein said energy beam is generated externally to said spectrometer.

7. A scanning Von Hamos X-ray spectrometer as recited in claim 1, further comprising a second diffractor positioned to reflect and diffract said X-rays, wherein said second diffractor is offset from said diffractor along said optical axis.

8. A scanning Von Hamos X-ray spectrometer as recited in claim 1, wherein said diffractor and said occluder are both radially symmetric about said optical axis.

9. A scanning Von Hamos X-ray spectrometer as recited in claim 2, further comprising an aperture controlling the admittance of said X-rays to said detector, wherein said aperture moves with said detector.

10. A scanning Von Hamos X-ray spectrometer as recited in claim 1, further comprising an aperture block located on said optical axis between said sample and said detector.

11. A scanning Von Hamos X-ray spectrometer, comprising:
a. a central optical axis;
b. a sample located proximate said central optical axis;
c. an energy beam bombarding said sample in order to produce X-rays;
d. a diffractor, positioned to diffract and reflect said X-rays back toward said central optical axis;
e. a movable occluder, positioned between said sample and said diffractor, wherein said movable occluder selectively occludes a portion of said X-rays striking said diffractor, thereby limiting the angular range of said X-rays being diffracted and reflected back toward said central optical axis;
f. a detector capable of detecting said reflected and diffracted X-rays, said detector being aligned with said central optical axis and facing said sample; and
g. wherein said detector is movable along said central axis.

12. A scanning Von Hamos X-ray spectrometer as recited in claim 11, said movable occluder comprising a pair of annular occluders forming an annular gap therebetween.

13. A scanning Von Hamos X-ray spectrometer as recited in claim 11, further comprising an aperture controlling the admittance of said X-rays to said detector, wherein said aperture moves with said detector.

14. A scanning Von Hamos X-ray spectrometer as recited in claim 13, wherein said aperture is adjustable.

15. A scanning Von Hamos X-ray spectrometer as recited in claim 11, wherein said energy beam is generated by an on-axis energy beam generator located on said optical axis and facing away from said detector.

16. A scanning Von Hamos X-ray spectrometer as recited in claim 11, wherein said energy beam is generated externally to said spectrometer.

17. A scanning Von Hamos X-ray spectrometer as recited in claim 11, further comprising a second diffractor positioned to diffract and reflect said X-rays back toward said central optical axis, wherein said second diffractor is offset from said diffractor along said optical axis.

18. A scanning Von Hamos X-ray spectrometer as recited in claim 11, wherein said diffractor and said occluder are both radially symmetric about said optical axis.

19. A scanning Von Hamos X-ray spectrometer as recited in claim 12, further comprising an aperture controlling the admittance of said X-rays to said detector, wherein said aperture moves with said detector.

20. A scanning Von Hamos X-ray spectrometer as recited in claim 11, further comprising an aperture block located on said optical axis between said sample and said detector.
